(19) United States
(12) Patent Application Publication
(10) Pub. No.: US 2007/0288391 A1
(43) Pub. Date: Dec. 13, 2007

(54) APPARATUS, INFORMATION PROCESSING APPARATUS, MANAGEMENT METHOD, AND INFORMATION PROCESSING METHOD

(75) Inventors: Mitsuhiro Nakamura, Tokyo (JP); Atsushi Nakamura, Tokyo (JP); Youji Kawamoto, Tokyo (JP); Motomasa Futagami, Kanagawa (JP); Seiichi Adachi, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 11/742,076

(22) Filed: Apr. 30, 2007

(30) Foreign Application Priority Data
May 11, 2006 (JP) 2006-132511

(51) Int. Cl. G06F 17/00

(52) U.S. Cl. 705/59

(57) ABSTRACT

A management apparatus supplying a license for use of content to an information processing apparatus includes a group management unit that registers at least one information processing apparatus in each group and delivers a group key specific to each group to the information processing apparatus; a storage unit that stores an ID of the information processing apparatus associated with a group ID of the group and the group key; a license issuing unit that issues a license including use conditions of the content and a content key with which encrypted content is decrypted, at least either of the use conditions of the content and the content key being encrypted with the group key; and a right information issuing unit that issues right information used for permitting the use of the content in a specified usage mode on the basis of the license to the permitted information processing apparatus.

### CROSS REFERENCES TO RELATED APPLICATIONS

The present invention contains subject matter related to Japanese Patent Application JP 2006-132511 filed in the Japanese Patent Office on May 11, 2006, the entire contents of which are incorporated herein by reference.

### BACKGROUND OF THE INVENTION

1. Field of the Invention

The present invention relates to a management apparatus, an information processing apparatus, a management method, and an information processing method, which protect the copyright of content.

2. Description of the Related Art

In recent years, services for delivery of digital content (hereinafter referred to as content), such as music content or video content, from servers storing the content to information processing apparatuses, such as personal computers (PCs) or mobile phones, owned by users have been offered. Since the quality of the content is not degraded even if the content is reproduced or transmitted a number of times, copyright protection technologies of restricting the use of content attract widespread attention.

Management methods for the copyright protection technologies are broadly divided into device binding and user binding. In the device binding, the servers restrict supply of licenses in which use conditions including the number of times of playback of content and the number of times of export of content are defined to certain information processing apparatuses (refer to Japanese Unexamined Patent Application Publication No. 2001-175524). In the user binding, the servers grant the license of content to the information processing apparatuses in a certain group among groups of information processing apparatuses. The export means generation of a license by a copyright protection technology on the basis of a license generated by another copyright protection technology.

Since the number of users who own multiple information processing apparatuses has recently increased and the device binding in which the use of content is restricted to certain information processing apparatuses is complicated for the users, the user binding is increasingly adopted as the management method for the copyright protection technologies.

### SUMMARY OF THE INVENTION

However, in the user binding, the license can be freely copied between the information processing apparatuses registered in the same group. Accordingly, for example, if a new information processing apparatus is additionally registered in the group, the number of times when the content can be exported in the group increases. Consequently, there is a problem in that it is not possible to practically restrict the number of times of export permitted to each group.

It is desirable to provide new and improved management apparatus, information processing apparatus, management method, and information processing method, which are capable of restricting use of content in a specified usage mode to one or more certain information processing apparatuses among the information processing apparatuses registered in each group.

According to an embodiment of the present invention, a management apparatus supplying a license for use of content to an information processing apparatus includes a group management unit configured to register at least one information processing apparatus in each group and to deliver a group key specific to each group to the information processing apparatus registered in the group; a storage unit configured to store an ID of the information processing apparatus registered in each group, a group ID of the group to which the information processing apparatus belongs, and the group key, which are in associated with each other; a license issuing unit configured to issue a license which includes use conditions of the content and a content key with which encrypted content is decrypted and in which at least either of the use conditions of the content and the content key is encrypted with the group key, in response to a request from the information processing apparatus; and a right information issuing unit configured to issue right information used for permitting the use of the content in a specified usage mode on the basis of the license to the information processing apparatus registered in the group, to which the use of the content in the specified usage mode is permitted.

With this configuration, since at least either of the use conditions of the content and the content key, included in the license issued by the management apparatus, is encrypted with the user key, only the information processing apparatus having the user key is permitted to use the license. In addition, the use of the content on the basis of the license in a specified usage mode is restricted to the information processing apparatus that has received the issuance of the right information corresponding to the specified usage mode. Accordingly, for example, the management apparatus can issue the license and the right information on the export to a certain information processing apparatus to permit only the certain information processing apparatus to export the content.

The information processing apparatus may be registered in the group of each user who owns the information processing apparatus.

The right information may include a right information ID specific to the right information. The right information ID associated with at least one usage mode of the content may be described in the use conditions in the license. With this configuration, the management apparatus can describe the right information ID associated with a specified usage mode in the use conditions in the license to be issued to restrict the use of the content in the usage mode to the information processing apparatus to which the right information corresponding to the right information ID has been issued. Consequently, for example, if the ID of the right information A on the export is described in the use conditions in the license issued by the management apparatus, only the information processing apparatus that has received the issuance of the right information A can export the content.

The license may include multiple types of content keys corresponding to the usage modes of the content and at least any of the multiple types of content keys may be encrypted with a use key. The right information may include the use key with which the encrypted content is decrypted. With this configuration, the management apparatus can encrypt the content key corresponding to any of the usage modes included in the license to be issued with the use key to restrict the use of the content to the information processing apparatus to which the right information including the use key with which the content key is decrypted has been issued. Consequently, for example, if the export content key included in the license issued by the management apparatus is encrypted with the use key, only the information processing apparatus having the right information including the use key with which the export content key is decrypted can export the content.

The right information issuing unit may restrict the number of the information processing apparatuses to which the right information can be issued so as not to exceed a predetermined upper limit for every usage mode of the content in each registered group of the information processing apparatus owned by the same user. With this configuration, the right information issuing unit can store the number of the information processing apparatuses to which the right information has been issued and can control the number so as not to exceed a predetermined maximum number of the information processing apparatuses to restrict the number of the information processing apparatuses that can use the content in a specified usage mode so as not to exceed the predetermined maximum number of the information processing apparatuses for every group. For example, if the maximum number of the information processing apparatuses to which the right information on the export can be issued in the group of a user is set to three, the number of the information processing apparatuses that can export the content in the group of the user is restricted to three.

The storage unit may store the ID of the information processing apparatus to which the right information has been issued in association with the group ID of the group. With this configuration, since the management apparatus stores the information processing apparatus to which the right information has been issued, the management apparatus can determine whether the right information ahs been issued to an information processing apparatus if a request to cancel the registration of the information processing apparatus is submitted from the information processing apparatus. Consequently, if the right information has been issued to the information processing apparatus, the number of the information processing apparatuses to which the right information can been issued is decreased in the group of the user to update the remaining number of the information processing apparatuses that can receive the issuance of the right information in the group.

The storage unit may store the remaining number of times when the content can be used in association with the group ID for every usage mode in the registered group of the information processing apparatus. The license issuing unit may issue the license in which a state value for every usage mode is set, the state value not exceeding the remaining number of times of use stored in the storage unit, and may update the remaining number of times of use on the basis of the set state value. With this configuration, it is possible to restrict the number of times of use of the content in the information processing apparatuses owned by a user to a predetermined upper limit of the number of times of use for every usage mode.

The group management unit may receive the state value for every usage mode of the content from the information processing apparatus, along with a request to cancel the registration of the information processing apparatus registered in the group, to update the remaining number of times of use on the basis of the state value. With this configuration, it is possible to strictly manage the number of times of use of the content in a certain group for every usage mode.

The right information issuing unit may add a signature to the right information. With this configuration, the information processing apparatus that has received the issuance of the right information can verify the signature to confirm the validity of the content of the right information.

According to another embodiment of the present invention, an information processing apparatus includes a storage unit configured to store a group key, a license, and right information used for permitting the use of content in a predetermined usage mode on the basis of the license, the group key being specific to a group in which at least one information processing apparatus is registered by a management apparatus, the license including use conditions of the content and a content key with which encrypted content is decrypted, at least either of the use conditions of the content and the content key being encrypted with the group key; and a use controlling unit configured to decrypt the license with the group key stored in the storage unit in response to a request to use the content in a specified usage mode to control the use of the content on the basis of the decrypted license and the presence of the right information corresponding to the specified usage mode.

With this configuration, if the use controlling unit receives a request to use the content in a specified usage mode, the use controlling unit controls the use of the content on the basis of the presence of the license permitting the use of the content, the use conditions in the license, and the presence of the right information corresponding to the specified usage mode. Consequently, if the license corresponding to the content to be used is granted, the use conditions in the license are met, and the right information corresponding to the specified usage mode exists, the information processing apparatus can use the content in the specified usage mode.

The right information may include a right information ID specific to the right information. The right information ID associated with at least one usage mode of the content may be described in the use conditions in the license. The use controlling unit may control the use of the content in the usage mode including the right information ID described in the use conditions in the license on the basis of whether the right information corresponding to the right information ID exists.

With this configuration, the information processing apparatus can use the content in the usage mode described in the use conditions in the license in association with the right information ID only if the information processing apparatus has the right information corresponding to the right information ID. Consequently, for example, if the ID of the right information A is described in the use conditions in the license in association with the export, only the information processing apparatus having the right information A can export the content.

The license may include multiple types of content keys corresponding to the usage modes of the content and at least any of the multiple types of content keys may be encrypted with a use key. The right information may include the use key with which the encrypted content key is decrypted. The use controlling unit may control the use of the encrypted content key corresponding to the specified usage mode on the basis of whether the right information including the use key with which the encrypted content key is decrypted exists.

With this configuration, the use of the content in the usage mode corresponding to the encrypted content key included in the license can be restricted to the information processing apparatus having the right information corresponding to the encrypted content key. For example, if the export content key is encrypted, only the information processing apparatus having the right information corresponding to the export content key can export the content.

The information processing apparatus may further include a content using unit configured to use the content in a specified usage mode if the use controlling unit permits the use of the content in the specified usage mode; and a state storage unit configured to store a state value, which indicates the number of times when the content can be used, described for every usage mode in the use conditions in the license. With this configuration, the number of times when the information processing apparatus can use the content can be stored and managed as the state value for every usage mode.

The information processing apparatus may further include a registration processing unit configured to transmit the state value stored in the state storage unit to the management apparatus in cancellation of the registration of the information processing apparatus. With this configuration, it is possible for the management apparatus to update the number of times of use of the content assignable to a user for every usage mode, that is, the remaining number of times of use.

A signature may be added to the right information and the use controlling unit may verify the validity of the right information on the basis of the signature. With this configuration, since the use controlling unit verifies whether the right information is tampered or whether the right information is formally issued by the management apparatus, it is possible to normally operate the system.

The registration processing unit may transmit an ID of the information processing apparatus and an ID of a user who owns the information processing apparatus to the management apparatus when a request to register the information processing apparatus in the group is submitted to the management apparatus. With this configuration, the management apparatus can identify the user of the group in which the information processing apparatus is registered.

According to another embodiment of the present invention, a management method of supplying a license for use of content to an information processing apparatus includes the steps of registering at least one information processing apparatus which belongs to the same group in one group; delivering a group key specific to the group to the information processing apparatus registered in the group; storing an ID of the information processing apparatus registered in the same group, a group ID of the group to which the information processing apparatus belongs, and the group key, which are associated with each other; issuing a license which includes use conditions of the content and a content key with which encrypted content is decrypted and in which at least either of the use conditions of the content and the content key is encrypted with the group key; and issuing right information used for permitting the use of the content in a specified usage mode on the basis of the license to the information processing apparatus registered in the group, to which the use of the content in the specified usage mode is permitted.

With this configuration, since at least either of the use conditions of the content and the content key, included in the license issued by the management apparatus, is encrypted with the user key, the use of the license is permitted only to the information processing apparatus having the user key. In addition, the use of the content in a specified usage mode on the basis of the license is restricted to the information processing apparatus to which the right information corresponding to the specified usage mode has been issued. Consequently, for example, the management apparatus can issue the license and the right information on the export to a certain information processing apparatus to permit the export of the content only to the information processing apparatus.

According to another embodiment of the present invention, an information processing method includes the steps of storing a group key, a license, and right information used for permitting the use of content in a predetermined usage mode on the basis of the license in a storage unit, the group key being specific to a group in which at least one information processing apparatus is registered by a management apparatus, the license including use conditions of the content and a content key with which encrypted content is decrypted, at least either of the use conditions of the content and the content key being encrypted with the group key; decrypting the license with the group key in response to a request to use the content in a specified usage mode; and controlling the use of the content on the basis of the use conditions in the decrypted license and the presence of the right information corresponding to the specified usage mode.

With this configuration, if the information processing apparatus receives a request to use the content in a specified usage mode, the information processing apparatus controls the use of the content on the basis of the presence of the license permitting the use of the content, the use conditions in the license, and the presence of the right information corresponding to the specified usage mode. Consequently, if the license corresponding to the content to be used is granted, the use conditions in the license are met, and the right information corresponding to the specified usage mode exists, the information processing apparatus can use the content in the specified usage mode.

As described above, the management apparatus, the information processing apparatus, the management method, and the information processing method according to the embodiments of the present invention can restrict the use of the content in a specified usage mode to one or more certain information processing apparatuses among the information processing apparatuses registered in each group.

### BRIEF DESCRIPTION OF THE DRAWINGS

FIG. 1 illustrates a content delivery system according to a first embodiment of the present invention;

FIG. 2 is a block diagram showing an example of the hardware configuration of a management server according to the first embodiment of the present invention;

FIG. 3 is a block diagram showing an example of the configuration of the management server according to the first embodiment of the present invention;

FIG. 4 illustrates a user key generated by a user key generator according to the first embodiment of the present invention;

FIG. 5 illustrates an example of the data structure of a license issued by a license issuer according to the first embodiment of the present invention;

FIG. 6 illustrates an example of the data structure of right information according to the first embodiment of the present invention;

FIG. 7 illustrates an example of a table of the right information, stored in a group storage unit according to the first embodiment of the present invention;

FIG. 8 illustrates an example of a table showing the number of times of use for every usage mode, stored in the group storage unit according to the first embodiment of the present invention;

FIG. 9 is a block diagram showing an example of the configuration of an information processing apparatus according to the first embodiment of the present invention;

FIG. 10 shows examples of state values about use of content, stored in a storage unit according to the first embodiment of the present invention;

FIG. 11 is a sequence chart showing an example of a process of registering a user of the information processing apparatus in the management server according to the first embodiment of the present invention;

FIG. 12 is a sequence chart showing an example of a process of issuing the license and the right information in the management server according to the first embodiment of the present invention;

FIG. 13 is a sequence chart showing an example of a process of canceling the registration of the apparatus in the information processing apparatus according to the first embodiment of the present invention;

FIG. 14 is a flowchart showing an example of a process of using the content in the information processing apparatus according to the first embodiment of the present invention;

FIG. 15 is a block diagram showing an example of the configuration of a management server according to a second embodiment of the present invention;

FIG. 16 illustrates an example of the structure of a license issued by a license issuer according to the second embodiment of the present invention;

FIG. 17 illustrates an example of the structure of playback right information issued by a right information issuer according to the second embodiment of the present invention;

FIG. 18 illustrates an example of the structure of export right information issued by the right information issuer according to the second embodiment of the present invention; and

FIG. 19 is a flowchart showing an example of an operational flow of an information processing apparatus according to the second embodiment of the present invention.

### DESCRIPTION OF THE PREFERRED EMBODIMENTS

Embodiments of the present invention will now be described in detail with reference to the attached drawings. The same reference numerals are used in this specification and drawings to identify the components having substantially the same functions and configurations. A description of such components is omitted herein.

### First Embodiment

A content delivery system according to a first embodiment of the present invention will now be described briefly.

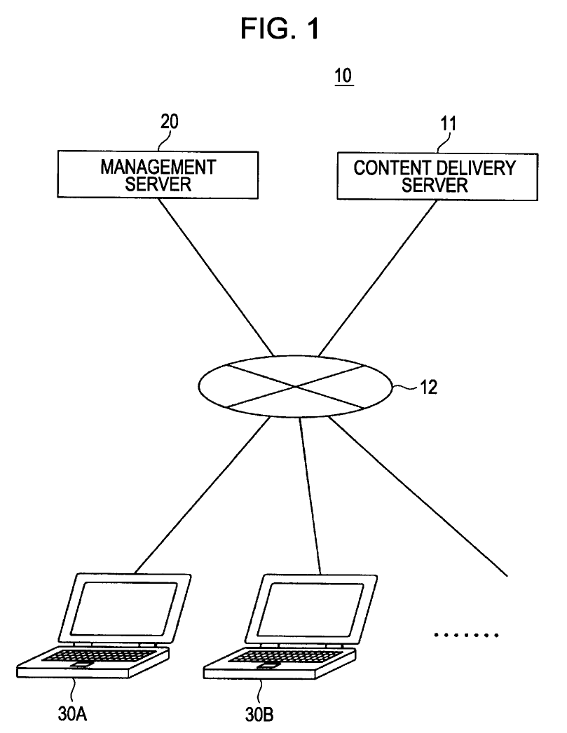

FIG. 1 illustrates a content delivery system 10 according to the first embodiment of the present invention. The content delivery system 10 at least includes a content delivery server 11, a communication network 12, a management server 20, an information processing apparatus 30A, and an information processing apparatus 30B (an information processing apparatus 30 denotes any of the information processing apparatuses).

The content delivery server 11 delivers encrypted content to the information processing apparatuses 30A and 30B over the communication network 12 in response to a request from the information processing apparatuses. The content is a concept including music data concerning music, lectures, and radio programs, video data concerning movies, television programs, video programs, photos, pictures, and diagrams, and arbitrary data concerning games and software.

The management server 20 registers one or more information processing apparatuses 30 owned by the same user in one group and functions as a management apparatus. The management server 20 issues a license for use of the encrypted content delivered from the content delivery server 11 to each group of the registered information processing apparatuses owned by the same user.

Specifically, the license includes a content key with which the encrypted content is decrypted and use conditions to restrict the use of the content. The content is used in various usage modes corresponding to the above types of the content. For example, music content can be used in the usage modes including playback, export, copy, and backup. Video content can be used in the usage modes including playback, export, edit, copy, display, and print. The “issuance” means generation and/or transmission of a target.

Accordingly, it is possible to restrict the number of times when the content is played back or exported, the sum of the playback times, the sum of the number of printable pages, and the time period during which the content can be used since the content is first used on the basis of the use conditions.

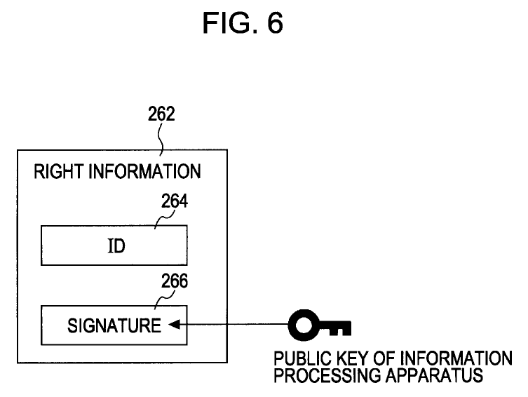

The management server 20 according to the first embodiment of the present invention also issues right information used for permitting one or more certain usage modes to each information processing apparatus. The right information will be described in detail below with reference to FIGS. 5 and 6.

The information processing apparatus 30 uses the encrypted content delivered from the content delivery server 11 on the basis of the license and right information issued by the management server 20. The information processing apparatuses 30A and 30B, which are registered in one group of the information processing apparatuses owned by the same user, are connected to each other via the communication network 12 or by a wired cable. The information processing apparatuses 30A and 30B can share the content and the license.

Although the PC is shown as the information processing apparatus 30 in the example shown in FIG. 1, the information processing apparatus may be a mobile phone, a portable music player, or a portable video playback apparatus. The number of the information processing apparatuses owned by the same user is not limited to two and the same user may own three or more information processing apparatuses.

The hardware configuration of the management server 20 according to the first embodiment of the present invention will now be described.

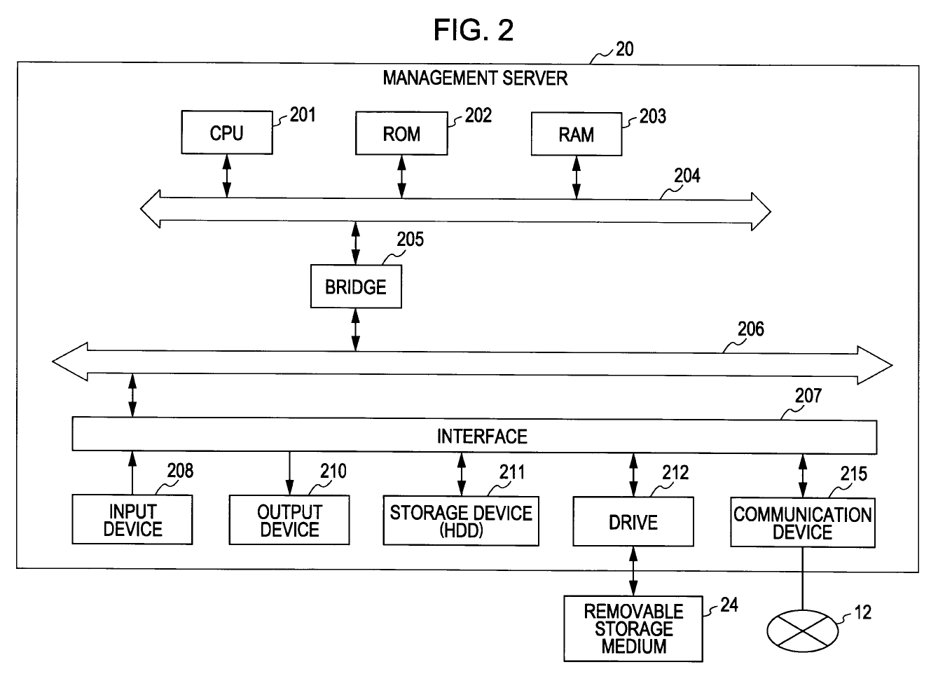

FIG. 2 is a block diagram showing an example of the hardware configuration of the management server 20 according to the first embodiment of the present invention. The management server 20 includes a central processing unit (CPU) 201, a read only memory (ROM) 202, a random access memory (RAM) 203, a host bus 204, a bridge 205, an external bus 206, an interface 207, an input device 208, an output device 210, a storage device (hard disk drive (HDD)) 211, a drive 212, and a communication device 215.

The CPU 201 functions as an arithmetic processing unit and a control unit. The CPU 201 controls the operations in the management server 20 in accordance with various programs. The ROM 202 stores the programs, arithmetic parameters, and so on used by the CPU 201. The RAM 203 temporarily stores the programs used in execution of the CPU 201 and the parameters appropriately varying in the execution of the CPU 201. The CPU 201, the ROM 202, and the RAM 203 are connected to each other via the host bus 204, such as a CPU bus.

The host bus 204 is connected to the external bus 206, such as Peripheral Component Interconnect (PCI) bus, via the bridge 205.

The input device 208 includes an operation unit, such as a mouse, a keyboard, a touch panel, buttons, switches, and a lever, operated by a user and an input control circuit that generates an input signal in response to an operation by the user to supply the generated input signal to the CPU 201. The user of the management server 20 operates the input device 208 to input a variety of data in the management server 20 or to instruct the management server 20 to perform processing operations.

The output device 210 includes a display unit, such as a cathode ray tube (CRT) display unit, a liquid crystal display (LCD) unit, or a lamp, and an audio output unit including a speaker and a headphone. The output device 210 outputs, for example, content that is played back. Specifically, the display unit displays a variety of information, such as video data, which is played back as a text or an image. The audio output unit converts the audio data that is played back into an audio to output the audio.

The storage device 211 is a data storage device, for example, an HDD, which is an example of a storage unit in the management server 20 according to the first embodiment of the present invention. The storage device 211 drives the hard disk and stores the programs executed by the CPU 201 and a variety of data. Device IDs, information concerning the information processing apparatuses to which the license and the right information are issued, the remaining number of time of use, which are associated with users, are stored in the storage device 211.

The drive 212 is a reader-writer for a storage medium. The drive 212 is incorporated in the management server 20 or is externally attached to the management server 20. The drive 212 reads out information recorded in a removable storage medium 24, such as a magnetic disk, an optical disk, a magneto-optical disk, or a semiconductor memory, which is loaded in the drive 212, and outputs the readout information to the RAM 203.

The communication device 215 is a communication interface used for connecting the management server 20 to the communication network 12. The communication device 215 transmits and receives a variety of information including content information, a domain key, the license, and the right information to and from the content delivery server 11 and/or the information processing apparatuses 30A and 30B over the communication network 12.

Since the hardware configuration of the information processing apparatus 30 is substantially the same as that of the management server 20, a description of the hardware configuration of the information processing apparatus 30 is omitted herein.

The configuration of the management server 20 according to the first embodiment of the present invention will now be described.

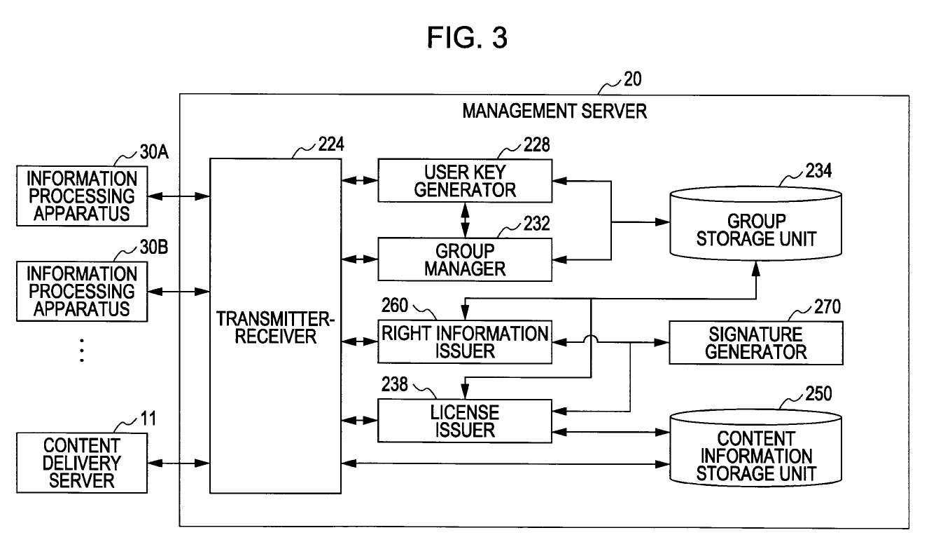

FIG. 3 is a block diagram showing an example of the configuration of the management server 20 according to the first embodiment of the present invention. The management server 20 includes a transmitter-receiver 224, a user key generator 228, a group manager 232, a group storage unit 234, a license issuer 238, a content information storage unit 250, a right information issuer 260, and a signature generator 270.

The transmitter-receiver 224 transmits and receives a variety of data to and from the content delivery server 11 and the information processing apparatuses 30A and 30B. For example, the transmitter-receiver 224 transmits and receives information concerning the encryption method of the content delivered from the content delivery server 11 to the information processing apparatus 30 to and from the content delivery server 11. The transmitter-receiver 224 transmits and receives the license and the right information described below to and from the information processing apparatus 30.

The user key generator 228 generates a user key in response to a group generation request according to the user binding or a device registration request from the group manager 232.

The user binding will be described briefly here. In the user binding, one or more information processing apparatuses owned by the same user are registered in one group and the content is shared between the information processing apparatuses in the registered group. Specifically, the user key with which the license issued by the management server 20 is decrypted is delivered to the information processing apparatuses that are registered in one group and that are owned by the same user. With this configuration, the license for the use of certain encrypted content can be decrypted only in the information processing apparatuses owned by the same user. In the user binding, the information processing apparatuses are not limitedly grouped on the basis of the same user and the information processing apparatuses may be grouped in arbitrary units. For example, one or more information processing apparatuses owned by the same family may be registered in one group. In this case, the user key according to the first embodiment of the present invention corresponds to a group key and the user ID corresponds to a group ID.

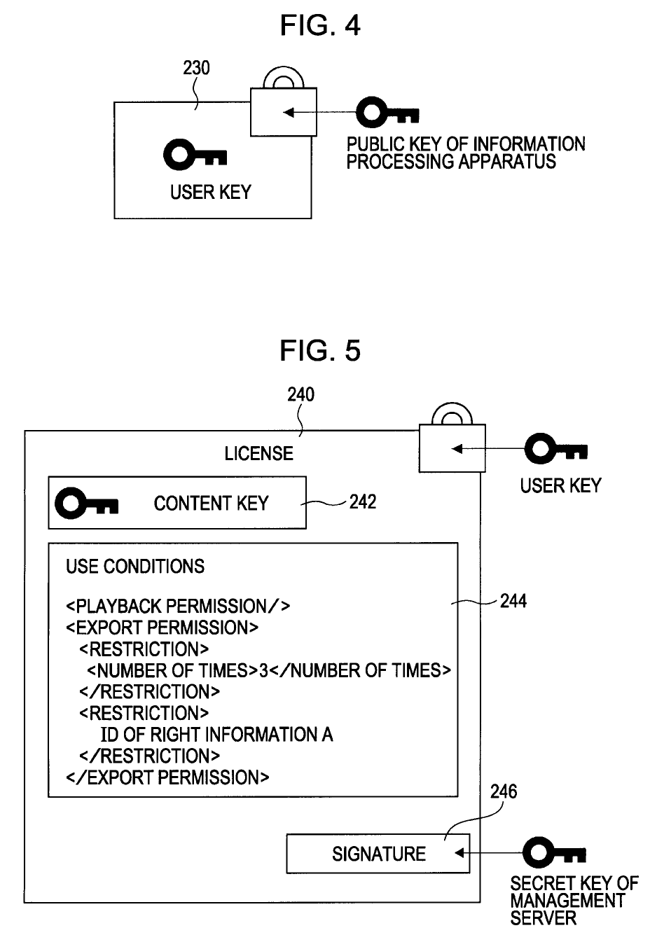

FIG. 4 illustrates a user key 230 generated by the user key generator 228. The user key 230 is encrypted with a public key specific to the information processing apparatus 30. Accordingly, only the information processing apparatuses having a secret key corresponding to the public key can decrypt the encrypted user key, so that the user key can be protected from being tampered or sniffed to be safely delivered. The user key is a decryption key specific to each user.

The user key generator 228 associates the generated user key 230 with the device ID of the information processing apparatus 30 to which the user key 230 is delivered and stores the user key associated with the device ID in the group storage unit 234.

Referring back to FIG. 3, the group manager 232 instructs the user key generator 228 to generate the user key in response to the group generation request or the device registration request from the information processing apparatus 30. The group manager 232 associates the user ID of the user with the device IDs of the information processing apparatuses 30 owned by the same user and stores the user ID associated with the device IDs in the group storage unit 234.

If a registration cancel request is submitted from any information processing apparatus registered in the group, the group manager 232 deletes the device ID of the information processing apparatus stored in the group storage unit 234. The group manager 232 is capable of limiting the number of information processing apparatuses registered in each group.

Specifically, the group manager 232 may store the remaining number of the information processing apparatuses that can be registered in the group of each user in the group storage unit 234 as a state value and may update the state value each time the information processing apparatus is registered or the registration of the information processing apparatus is canceled.

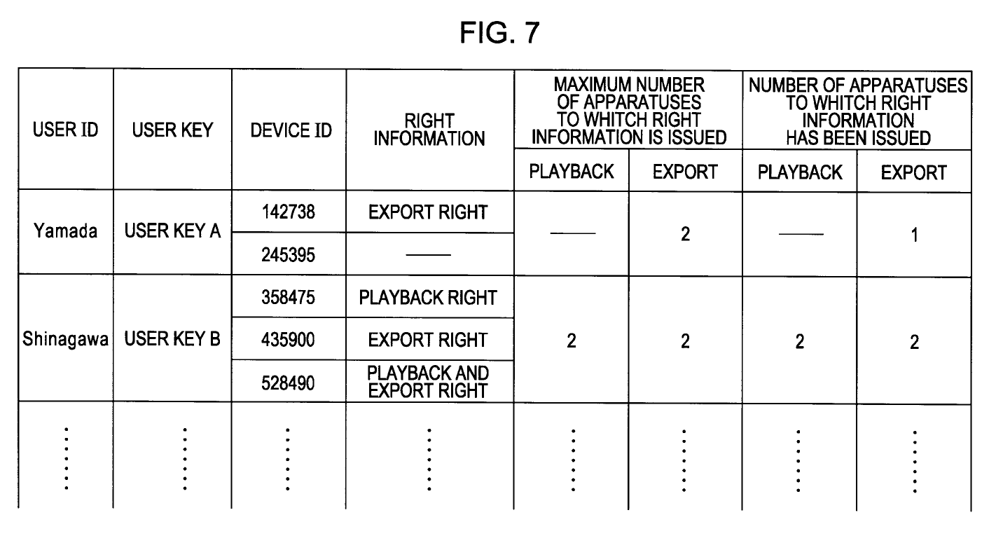

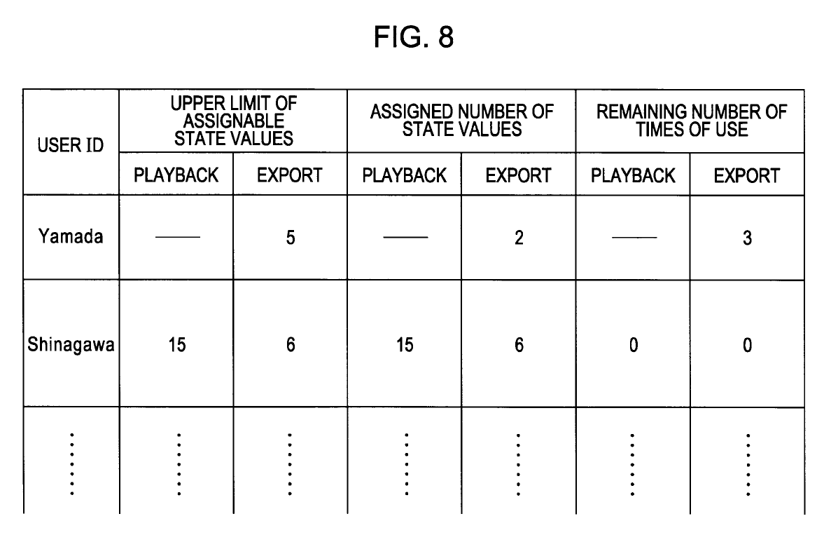

The group storage unit 234 associates, for example, the device IDs of the information processing apparatuses registered in the group of each user, the device IDs of the information processing apparatuses to which the right information is issued, and the number of the information processing apparatuses to which the right information can be issued with the user ID of the user and functions as a storage unit, which stores the device IDs or the number of the information processing apparatuses associated with the user ID. The structure of a table stored in the group storage unit 234 will be described in detail below with reference to FIGS. 7 and 8.

The license issuer 238 issues a license permitting the information processing apparatus 30 to use the content delivered from the content delivery server 11.

FIG. 5 illustrates the data structure of a license 240 according to the user binding issued by the license issuer 238. The license 240 includes a content key 242, use conditions 244, and a signature 246.

The content key 242 is a decryption key with which the encrypted content delivered from the content delivery server 11 is decrypted. If a request to issue a license for certain content is submitted, the content key 242 corresponding to the encryption key with which the content is encrypted is retrieved from the content information storage unit 250 and the retrieved content key 242 is included in the license. The use of the content key 242 is permitted if the use conditions 244 and the signature 246, described below, meet predetermined conditions.

Restrictions on the use of the content key 242 by the information processing apparatus 30 are described in the use conditions 244. In the use conditions 244 in FIG. 5, restrictions on the playback are not described. The content key 242 can be used with no restriction in the usage mode for which the restrictions are not described.

In contrast, restrictions on the number of times of export and the right information on the export are described in the use conditions 244 in FIG. 5. The number of times of export is limited to three in the example shown in FIG. 5. The number of times may be a state value. Specifically, the number of times may decrease each time the information processing apparatus 30 performs the export. Accordingly, if the number of times of export is zero, the information processing apparatus 30 is prohibited from performing the export.

The ID of right information A is also described in the use conditions 244 in the example shown in FIG. 5. When the ID of the right information associated with the usage mode is described in the use conditions 244 as in the example shown in FIG. 5, the use of the content can be restricted to any information processing apparatus having the right information corresponding to the ID of the right information described in the use conditions 244. With this data structure, it is possible to restrict the use of the content in a specified usage mode to part of the multiple information processing apparatuses that are owned by the same user and that are registered in the group of the user.

The signature 246 results from the encryption of the entire content of the license with the secret key of the management server 20 by the signature generator 270. Accordingly, if the signature can be decrypted with the public key of the management server 20, it is determined that the license is formally issued by the management server 20. In this case, the validity of the content of the license 240 can be verified. The signature generator 270 may generate the signature for every restriction on the usage mode of the content described in the use conditions 244.

As described above, since the license is encrypted with the user key, the use of the license is restricted to the information processing apparatuses or group having the user key. The user key with which the license is encrypted need not be the same as the user key with which the license is decrypted. The user key with which the license is encrypted may be asymmetric to the user key with which the license is decrypted.

Referring back to FIG. 3, the content information storage unit 250 associates the encrypted content which the content delivery server 11 has delivered to the information processing apparatus 30 with the content key with which the content is decrypted and stores the encrypted content associated with the content key. The license issuer 238 searches the content information storage unit 250 for a desired content key.

The content information storage unit 250 may store data concerning the content or a date and time when the content is delivered, in addition to the content key.

The right information issuer 260 issues the right information used for permitting the use of the content in a specified usage mode on the basis of the license by the information processing apparatus 30 to one or more information processing apparatuses to which the use of the content in the specified usage mode is permitted, among the information processing apparatuses registered in the group.

FIG. 6 illustrates the data structure of right information 262. The right information 262 includes a right information ID 264 and a signature 266.

The right information ID 264 is an identification number specific to the right information 262. The signature 266 encrypted by the user key generator 228 with the public key of the information processing apparatus 30 is added to the right information 262 so as to prevent the right information ID 264 from being tampered.

The right information issuer 260 may associate the device ID of the information processing apparatus issuing the right information 262 with the user ID and may store the device ID associated with the user ID in the group storage unit 234. With this structure, the user can access the group storage unit 234 to confirm which information processing apparatus, among the information processing apparatuses owned by the user, holds the right information.

Referring back to FIG. 3, the signature generator 270 cooperates with the license issuer 238 and the right information issuer 260 to add the signature to the license and the right information. With this structure, it is possible to prevent the tampering of the license and the right information and to assure the validity of the transmitter.

The group storage unit 234 will now be described in detail.

FIG. 7 illustrates an example of a table of the right information, stored in the group storage unit 234. User IDs, user keys, device IDs, types of the issued right information, the maximum numbers of the apparatuses to which the right information is issued, and the numbers of apparatuses to which the right information has been issued, which are associated with each other, are stored in the group storage unit 234.

In the example shown in FIG. 7, the user having a user ID “Yamada” registers his/her own information processing apparatuses “142738” and “245395” in the group. The information processing apparatuses “142738” and “245395” owned by the user having the user ID “Yamada” share a common user key A.

The management server 20 according to the first embodiment of the present invention can restrict the number of the information processing apparatuses to which the right information is issued for every usage mode of the content. The user having the user ID “Yamada” is not restricted in the number of the information processing apparatuses to which the right information on the playback is issued. However, the number of the information processing apparatuses to which the right information on the export is issued is limited to two for the user having the user ID “Yamada”.

Since the right information on the export has been issued to the information processing apparatus “142738”, the number of apparatuses to which the right information on the export has been issued is represented as one.

In contrast, the user having a user ID “Shinagawa” registers his/her own information processing apparatuses “358475”, “435900”, and “528490” in the group. The information processing apparatuses “358475”, “435900”, and “528490” owned by the user having the user ID “Shinagawa” share a common user key B. As in the example shown in FIG. 7, the number of the information processing apparatuses registered in the group may be varied for every user.

Both the number of the information processing apparatuses to which the right information on the playback is issued and the number of the information processing apparatuses to which the right information on the export is issued are limited to two for the user having the user ID “Shinagawa”. In addition, since the right information on the playback has been issued to the two information processing apparatuses and the right information on the example has been issued to the two information processing apparatuses, no more right information on the playback and the export can be issued to the information processing apparatuses owned by the user having the user ID “Shinagawa”.

However, if the right information on the export issued to the information processing apparatus “435900” is deleted, the number of the information processing apparatuses to which the right information on the export has been issued is updated to one and, therefore, the right information on the export can be issued to the information processing apparatus “358475”.

FIG. 8 illustrates an example of a table for a piece of the content, stored in the group storage unit 234. The table shows the number of times of use for every usage mode. The group storage unit 234 stores, for every piece of the content, the user IDs, the upper limit of assignable state values, the number of assigned state values, and the remaining number of times of use. With this structure, the management server 20 can restrict the state value for every usage mode described in the use conditions in the license to be issued.

The upper limit of assignable state values means the upper limit of the sum of the state values for every usage mode, which can be described in the use conditions in the license to be issued to a certain user, that is, which can be assigned to the certain user. In the example shown in FIG. 8, the sum of the assignable state values about the playback is not restricted but the sum of the assignable state values about the export is restricted to five for the user having a user ID “Yamada”.

The number of assigned state values means the sum of the state values for every usage mode, described in the use conditions in the license that has been issued to the information processing apparatuses owned by the same user. In the example shown in FIG. 8, the state value about the export has been assigned twice to the user having the user ID “Yamada”.

The remaining number of times of use means the number of the state values for every usage mode, which can be currently assigned to each user. In the example shown in FIG. 8, since the upper limit of assignable state values about the export is five and the number of assigned state values is two for the user having the user ID “Yamada”, the remaining number of times of use is three. Accordingly, the state value about the export can be assigned another three times to the user having the user ID “Yamada”.

In contrast, since the upper limit of assignable state values about the playback is 15 and that on the export is six and the number of assigned state values about the playback is 15 and that on the export is six for the user having a user ID “Shinagawa”, both the remaining number of times of use on the playback and the remaining number of times of use on the export are zero. However, if a request to cancel the registration of the information processing apparatus that is owned by the user having the user ID “Shinagawa” and that has the state value about the playback and the export is submitted, the state value of the information processing apparatus is also received to update the remaining number of times of use on the basis of the received state value.

The configuration of the information processing apparatus 30 according to the first embodiment of the present invention will now be described.

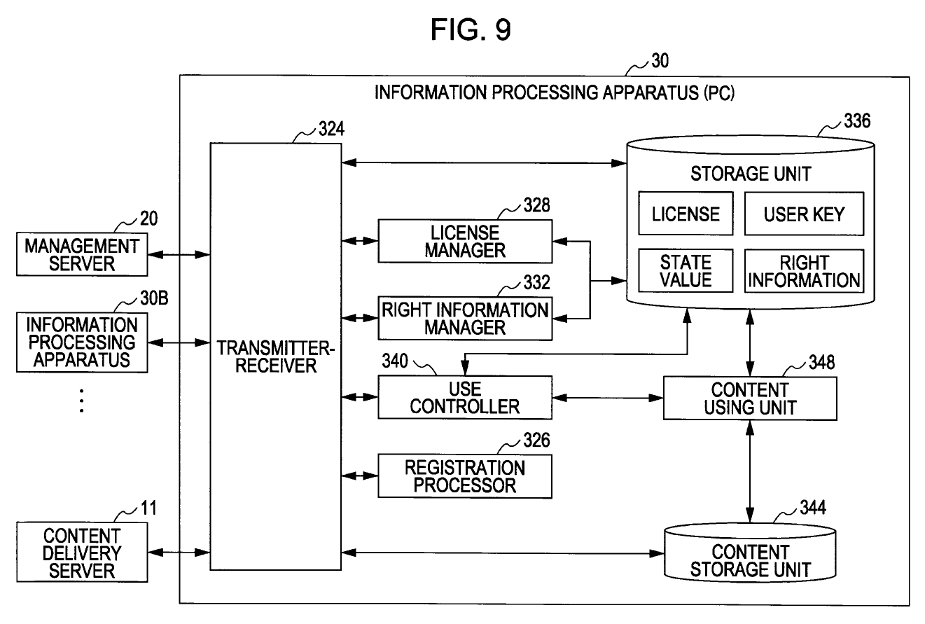

FIG. 9 is a block diagram showing an example of the configuration of the information processing apparatus 30 according to the first embodiment of the present invention. The information processing apparatus 30 includes a transmitter-receiver 324, a registration processor 326, a license manager 328, a right information manager 332, a storage unit 336, a use controller 340, a content storage unit 344, and a content using unit 348.

The transmitter-receiver 324 transmits and receives a variety of data to and from the content delivery server 11 and the management server 20. For example, the transmitter-receiver 224 transmits and receives the encrypted content to and from the content delivery server 11. The transmitter-receiver 324 transmits and receives the license and the right information to and from the management server 20.

The registration processor 326 registers the information processing apparatus 30 in the group of the information processing apparatuses owned by the same user or cancels the registration of the information processing apparatus 30 in the group. For example, in the registration of the apparatus, the registration processor 326 transmits the device ID of the information processing apparatus 30 and the user ID of the user who owns the information processing apparatus, along with a request to register the apparatus, to the management server 20.

In the cancellation of the registration of the apparatus, the registration processor 326 transmits the device ID of the information processing apparatus 30 and the state value described below, along with a request to cancel the registration of the apparatus, to the management server 20. In generation of a new group, the registration processor 326 requests the management server 20 to create an account and the management server 20 generates a user ID and a user key of the user who owns the information processing apparatus 30 in response to the request.

The license manager 328 requests the management server 20 to issue a license for the use of the encrypted content. The license manager 328 stores the license issued by the management server 20 in response to the request in the storage unit 336.

The right information manager 332 requests the management server 20 to issue the right information for permission of the use of the encrypted content in a specified usage mode. The right information manager 332 stores the right information issued by the management server 20 in response to the request in the storage unit 336.

The storage unit 336 stores the license, the state value, the right information, the user key, and so on. Since the license and the right information are described in detail with reference to FIGS. 5 and 6, a description of the license and the right information is omitted herein.

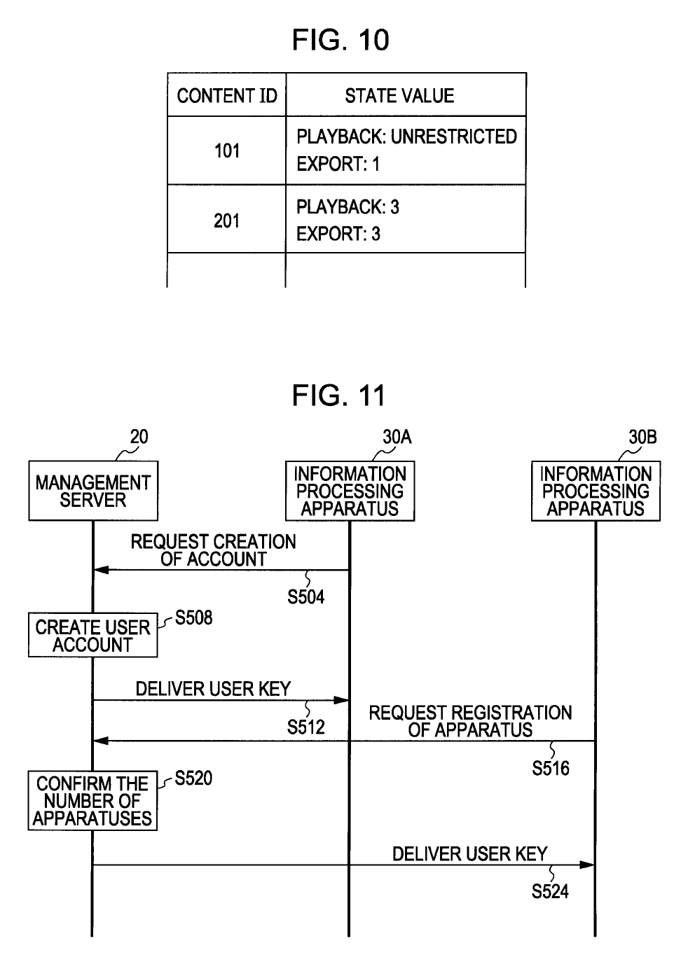

FIG. 10 shows examples of the state values about the use of the content, stored in the storage unit 336. The state value means the number of times of use of the content for every usage mode and is a variable or a status that is updated each time the content is used.

In the example shown in FIG. 10, since the state value about the export of content “101” is set to “one”, the remaining number of times when the content “101” can be exported is one. In contrast, since the number of times of playback is not restricted for the content “101”, the state value is not represented as a number.

Since the state values about the playback and the export of content “102” are set to three, the remaining number of times when the content “101” can be played back or exported is three. The state value need not be separately stored if the state value is included in the use conditions in the license.

Referring back to FIG. 9, the use controller 340 decrypts the license with the user key stored in the storage unit 336 in response to a request to use the content in a specified usage mode. The use controller 340, then, determines whether the content can be used on the basis of the decrypted license and the presence of the right information corresponding to the specified usage mode.

It is assumed that the content encrypted on the basis of the license 240 shown in FIG. 5 is to be exported. In this case, the use controller 340 decrypts the license 240 with the user key stored in the storage unit 336. The use controller 340, then, decrypts the signature 246 with the public key of the management server 20 to verify the validity of the license 240. If the verification of the signature 246 assures the validity of the license 240, the use controller 340 goes to the subsequent processing step.

The ID of the right information A used for restricting the export is described in the use conditions 244. Accordingly, the use controller 340 permits the export of the content if the storage unit 336 stores the right information A and the state value about the export is set to one or more.

The content storage unit 344 stores the encrypted content delivered from the content delivery server 11. The content storage unit 344 may store content acquired from a medium, such as a compact disc (CD) or a memory card.

The content using unit 348 reads out the content stored in the content storage unit 344, if the use controller 340 permits the use of the content, to use the readout content. For example, the content using unit 348 plays back, exports, or displays the readout content. The content using unit 348, then, updates the state value corresponding to the usage mode of the content, stored in the storage unit 336.

Operational flows of the management server 20 and the information processing apparatus 30 according to the first embodiment of the present invention will now be described.

FIG. 11 is a sequence chart showing an example of a process of registering a user of the information processing apparatus 30 in the management server 20 according to the first embodiment of the present invention. In Step S504, the information processing apparatus 30A requests the management server 20 to create an account or to register the group. The information processing apparatus 30A transmits the device ID specific to the information processing apparatus 30A, along with the request, to the management server 20.

In Step S508, the management server 20 creates a user account in response to the request to create an account from the information processing apparatus 30A. Specifically, the management server 20 creates a user ID and a password, which are requested when the information processing apparatus 30A accesses the management server 20, and a user key specific to the user who owns the information processing apparatus 30A.

After crating the user account, then in Step S512, the management server 20 delivers the user key to the information processing apparatus 30A. The information processing apparatus 30A decrypts the license issued by the management server 20 with the delivered user key.

In Step S516, the information processing apparatus 30B requests the management server 20 to register the information processing apparatus 30B in the group owned by the same user as that of the information processing apparatus 30A. The information processing apparatus 30B transmits the device ID specific to the information processing apparatus 30B, the user ID created in Step S508, and the password, along with the request, to the management server 20.

After receiving the request to register the information processing apparatus 30B from the information processing apparatus 30B, then in Step S520, the management server 20 performs user authentication to confirm the number of the information processing apparatuses currently registered in the group of the user. If the number of the information processing apparatuses currently registered in the group of the user does not exceed the maximum number of the information processing apparatuses that can be registered in the group, then in Step S524, the management server 20 permits the registration of the information processing apparatus 30B and delivers the same user key as that of the information processing apparatus 30A to the information processing apparatus 30B. In this manner, the information processing apparatus 30B is registered in the same group as that of the information processing apparatus 30A and can decrypt the license issued by the management server 20 with the delivered user key.

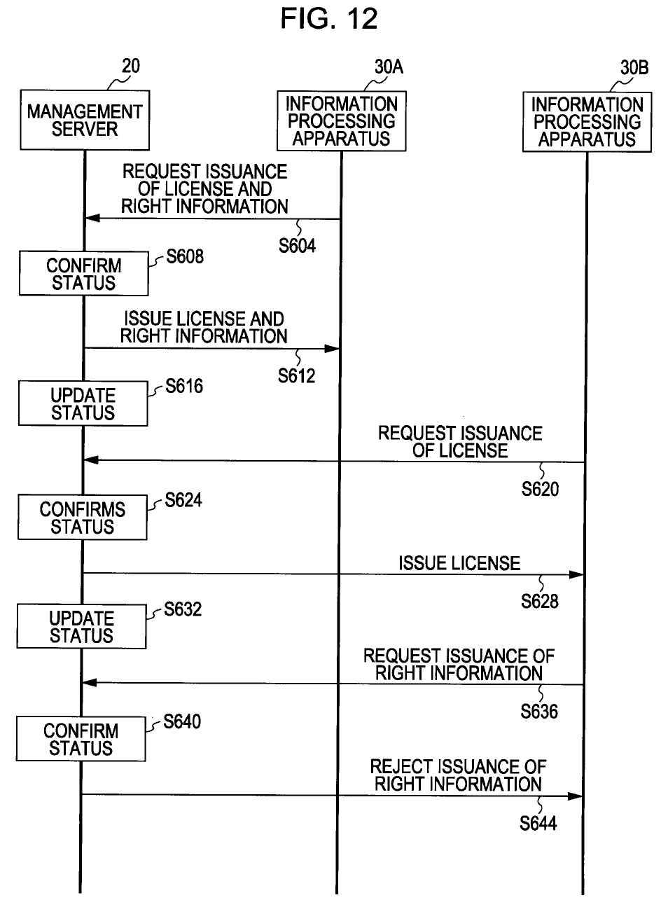

FIG. 12 is a sequence chart showing an example of a process of issuing the license and the right information in the management server 20 according to the first embodiment of the present invention. In the example shown in FIG. 12, it is assumed that the information processing apparatuses 30A and 30B have been registered in the group of the same user and have the same user key.

In Step S604, the information processing apparatus 30A requests the management server 20 to issue the license for the use of the encrypted content and the right information corresponding to a specified usage mode. The information processing apparatus 30A transmits the device ID of the information processing apparatus 30A, the user ID, and the password, along with the request, to the management server 20. It is assumed in the following description that the export is used as the specified usage mode.

After receiving the request to issue the license and the right information on the export from the information processing apparatus 30A, then in Step S608, the management server 20 performs the user authentication and confirms the status. The status is a concept including the remaining number of the information processing apparatuses to which the right information on the export can be issued for every user, shown in FIG. 7, and the remaining number of times of use shown in FIG. 8.

If the management server 20 confirms the status to determine that the right information on the export can be issued, then in Step S612, the management server 20 issues the right information on the export to the information processing apparatus 30A and also issues the license to the information processing apparatus 30A. In the license, the number of times of use for every usage mode, which does not exceed the remaining number of times of use, is set in the use conditions. In Step S616, the management server 20 updates the remaining number of the information processing apparatuses to which the right information on the export can be issued and the remaining number of times of use, that is, the status on the basis of the set number of time of use.

In Step S620, the information processing apparatus 30B requests the management server 20 to issue the license. The information processing apparatus 30B transmits the device ID of the information processing apparatus 30B, the user ID, and the password, along with the request, to the management server 20.

After receiving the request to issue the license from the information processing apparatus 30B, then in Step S624, the management server 20 performs the user authentication and confirms the status. In Step S628, the management server 20 generates a license on the basis of the status and issues the generated license to the information processing apparatus 30B. In Step S632, the management server 20 updates the status on the basis of the generated license.

In Step S636, the information processing apparatus 30B requests the management server 20 to issue the right information on the export. The information processing apparatus 30B transmits the device ID of the information processing apparatus 30B, the user ID, and the password, along with the request, to the management server 20.

After receiving the request to issue the right information on the export from the information processing apparatus 30B, then in Step S640, the management server 20 performs the user authentication and confirms the status. If the maximum number of the information processing apparatuses to which the right information on the export is issued is exceeded, then in Step S644, the management server 20 rejects the issuance of the right information on the export to the information processing apparatus 30B.

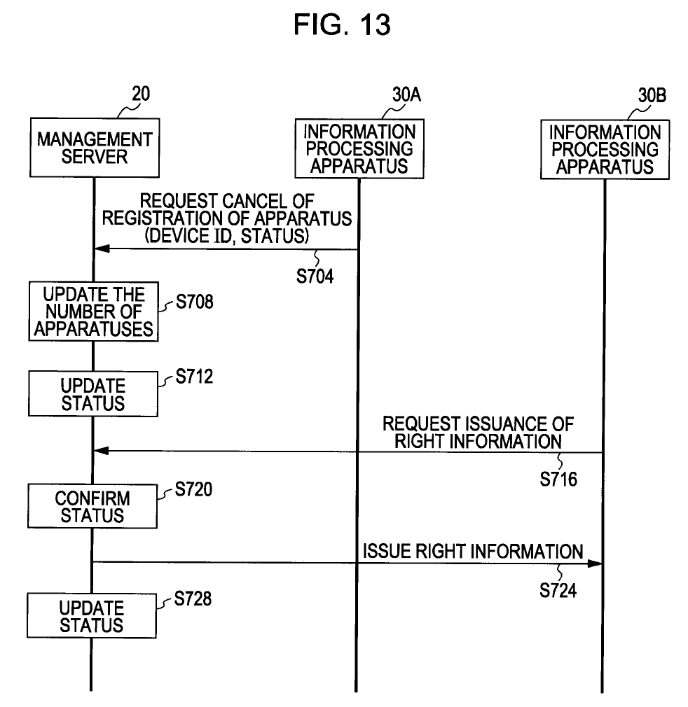

FIG. 13 is a sequence chart showing an example of a process of canceling the registration of the apparatus in the information processing apparatus 30 according to the first embodiment of the present invention.

In Step S704, the information processing apparatus 30A requests the management server 20 to cancel the registration of the information processing apparatus 30A in the group. The information processing apparatus 30A transmits the device ID of the information processing apparatus 30A, the user ID, the password, and the state value, along with the request, to the management server 20.

After receiving the request to cancel the registration of the information processing apparatus 30A from the information processing apparatus 30A, the management server 20 deletes the information processing apparatus 30A from the group of the user owning the information processing apparatus 30A. In Step S708, the management server 20 updates the remaining number of information processing apparatuses that can be registered in group of the same user. In Step S712, the management server 20 updates the status on the basis of the state value received from the information processing apparatus 30A.

Specifically, since the management server 20 stores the information processing apparatus 30 as the information processing apparatus to which the right information on the export has been issued, the management server 20 can update, that is, increase the number of the information processing apparatuses to which the right information on the export can be issued if the registration of the information processing apparatus 30A is canceled. In addition, the management server 20 can update the remaining number of times of use stored in the management server 20 on the basis of the received state value indicating the number of times when the content can be used for every usage mode.

It is assumed that the information processing apparatus 30B, for which the issuance of the right information on the export is rejected while the information processing apparatus 30A is registered in the group, requests again the management server 20 to issue the right information on the export. In this case, in Step S716, the information processing apparatus 30B transmits the device ID of the information processing apparatus 30B, the user ID, and the password to the management server 20 and requests the management server 20 to issue the right information on the export.

After receiving the request to issue the right information on the export from the information processing apparatus 30B, then in Step S720, the management server 20 performs the user authentication and confirms the status. Since the number of the information processing apparatuses to which the right information on the export can be issued is updated in Step S712, in Step S724, the information processing apparatus 30B is allowed to receive the issuance of the right information on the export. After issuing the right information on the export to the information processing apparatus 30B, then in Step S728, the management server 20 updates the status again. Specifically, the management server 20 updates the number of the information processing apparatuses to which the right information on the export can be issued and which are owned by the same user.

The use of the content by the information processing apparatus 30 according to the first embodiment of the present invention will now be described in detail.

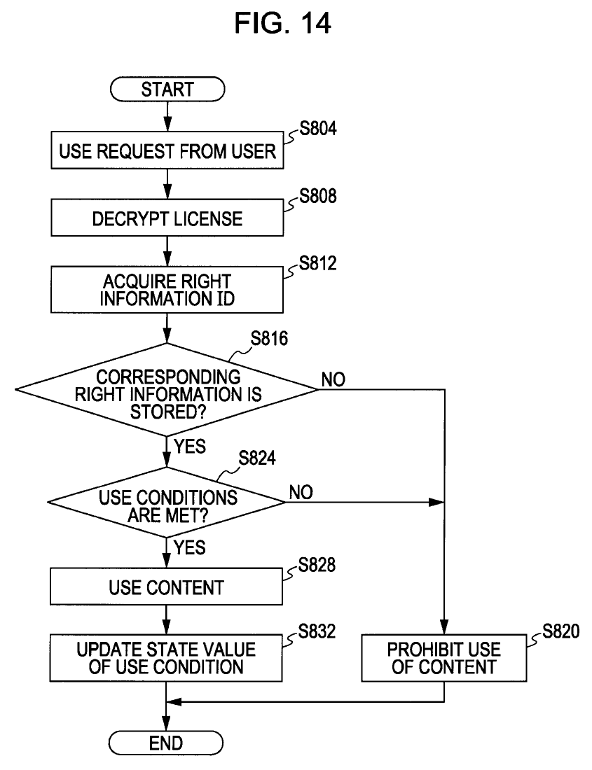

FIG. 14 is a flowchart showing an example of a process of using the content in the information processing apparatus 30 according to the first embodiment of the present invention. After receiving a request to export and use the encrypted content from the user, in Step S804, the information processing apparatus 30 supplies the license that corresponds to the encrypted content to be exported and that is stored in the storage unit 336 to the use controller 340.

In Step S808, the use controller 340 decrypts the license supplied from the storage unit 336 with the user key. In Step S812, the use controller 340 verifies the signature included in the license and, then, acquires the ID of the right information that is described in the use conditions in association with the export.

In Step S816, the use controller 340 determines whether the storage unit 336 stores the right information corresponding to the ID of the right information acquired in Step S812. If the corresponding right information is stored in the storage unit 336, the use controller 340 verifies the signature. If the use controller 340 determines that the storage unit 336 does not store the right information corresponding to the ID of the right information acquired in Step S812, then in Step S820, the use controller 340 prohibits the export of the encrypted content.

If the use controller 340 determines in Step S816 that the storage unit 336 stores the right information corresponding to the ID of the right information acquired in Step S812 and the validity of the right information is confirmed by the verification of the signature, then in Step S824, the use controller 340 determines whether the use conditions in the license are met. Specifically, the use controller 340 determines whether the state value about the export included in the license is a positive value. If the use controller 340 determines that the use conditions in the license are not met, then in Step S820, the use controller 340 prohibits the export of the encrypted content.

If the use controller 340 determines in Step S824 that the use conditions in the license are met, the use controller 340 permits the export of the encrypted content and, in Step S828, the content using unit 348 uses the content key to export the encrypted content.

In Step S832, the use controller 340 updates the state value about the export included in the license and terminates the process.

As described above, in the content delivery system 10 according to the first embodiment of the present invention, it is possible to restrict the use of the content in a specified usage mode in the information processing apparatuses 30 to the information processing apparatus having the right information corresponding to the ID of the right information described in the use conditions in the license.

The management server 20 according to the first embodiment of the present invention restricts the number of the information processing apparatuses to which the right information can be issued to a predetermined maximum number, so that the number of times of use for every usage mode, permitted to the group of a user, can be strictly managed.

The information processing apparatus to which the use of the content in a specified usage mode is permitted can be updated, if necessary. For example, if the ID of the right information A used in the restriction of the export of the content is described in the use conditions in the license, only the information processing apparatus having the right information A can export the content.

In order to update the information processing apparatus that can export the content, for example, the ID of the right information A described in the use conditions of the issued license is updated to the ID of the right information B and the right information B is issued to the information processing apparatus to which the export is permitted.

Accordingly, even the information processing apparatus which has the right information A and to which the export is permitted before the update of the license is prohibited from exporting the content unless the information processing apparatus receives the issuance of the right information B corresponding to the ID of the right information B described in the new license.

### Second Embodiment

A content delivery system according to a second embodiment of the present invention will now be described. The content delivery system according to the second embodiment of the present invention differs from the content delivery system according to the first embodiment of the present invention in that the management server 20 issues the license in which the content key is encrypted with a use key and the right information including the use key.

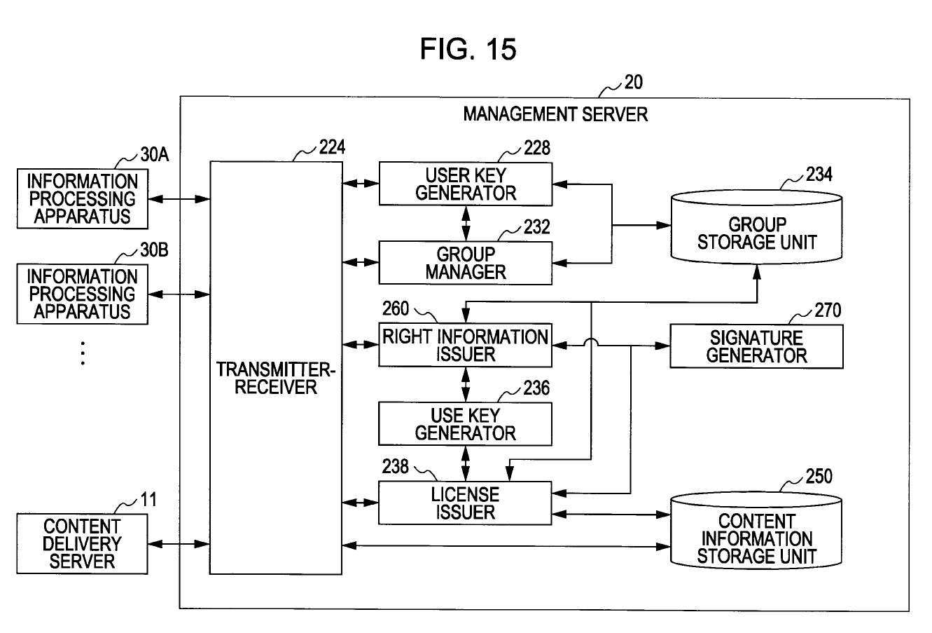

FIG. 15 is a block diagram showing an example of the configuration of the management server 20 according to the second embodiment of the present invention. The management server 20 includes a transmitter-receiver 224, a user key generator 228, a group manager 232, a group storage unit 234, a use key generator 236, a license issuer 238, a content information storage unit 250, a right information issuer 260, and a signature generator 270.

The functions and configurations of the transmitter-receiver 224, the user key generator 228, the group manager 232, the group storage unit 234, the content information storage unit 250, and the signature generator 270 are substantially the same as those in the first embodiment of the present invention. A detailed description of these components is omitted herein.

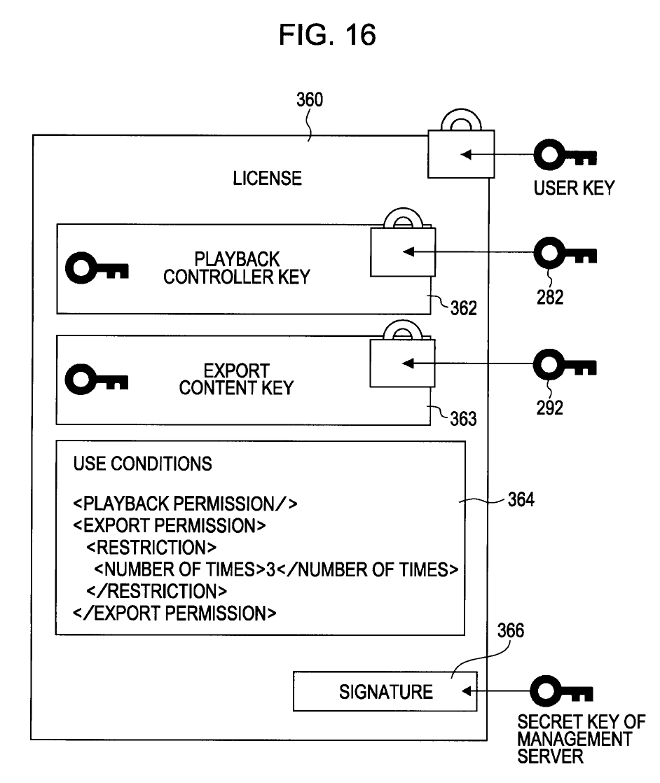

FIG. 16 illustrates the structure of a license 360 (according to the user binding) issued by the license issuer 238. The license 360 includes a playback content key 362, an export content key 363, use conditions 364, and a signature 366.

The license 360 includes multiple types of content keys corresponding to the usage modes. In the example shown in FIG. 16, the license 360 includes the playback content key 362 and the export content key 363. The playback content key 362 is encrypted with a playback use key 282 generated by the use key generator 236. The export content key 363 is encrypted with an export use key 292 generated by the use key generator 236.

With this structure, even the information processing apparatus that is owned by the same user and that has the user key with which the license is decrypted is restricted in the use of the content unless the information processing apparatus does not have the use key corresponding to each usage mode. Although the use key for the encryption is the same as the use key for the decryption in the example in FIG. 16, the use key for the encryption may be asymmetric to the use key for the decryption.

Although the content keys corresponding to all the usage modes are encrypted with the use keys in the example in FIG. 16, only the content keys corresponding to some of the usage modes may be encrypted with the use keys. In this case, no restriction is imposed on the use of the content with the content key that is not encrypted.

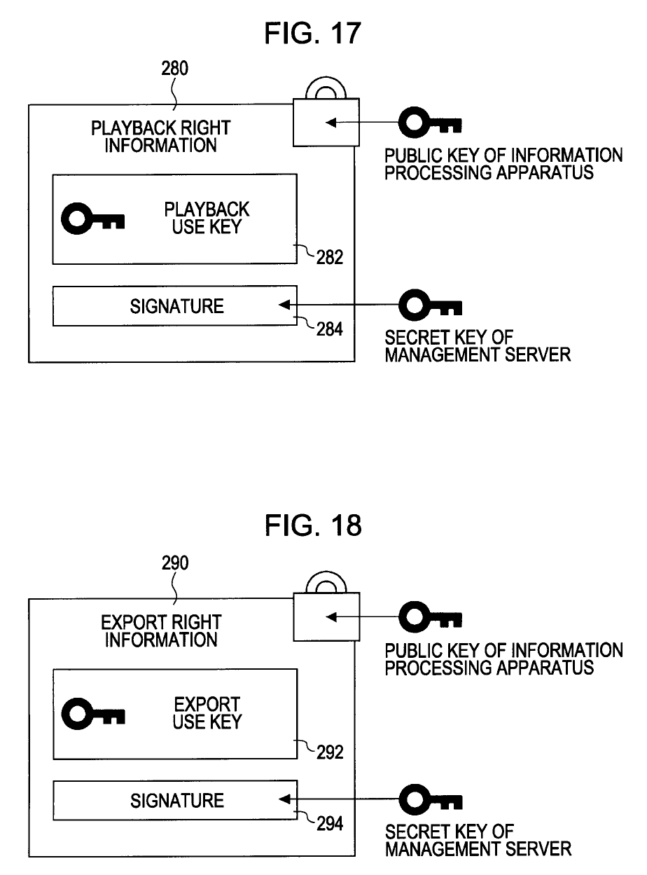

FIG. 17 illustrates the structure of playback right information 280 issued by the right information issuer 260. The playback right information 280 includes a playback use key 282 and a signature 284.

The playback use key 282 is generated by the use key generator 236, as described above. The playback use key 282 can be used to decrypt the encrypted playback content key 362. Accordingly, when the playback content key 362 is encrypted, the playback of the content delivered from the content delivery server 11 can be restricted to the information processing apparatus to which the playback right information 280 is issued.

FIG. 18 illustrates the structure of export right information 290 issued by the right information issuer 260. The export right information 290 includes an export use key 292 and a signature 294.

The export use key 292 is generated by the use key generator 236, as described above. The export use key 292 can be used to decrypt the encrypted export content key 363. Accordingly, when the export content key 363 is encrypted, the export of the content delivered from the content delivery server 11 can be restricted to the information processing apparatus to which the export right information 290 is issued.

The signature encrypted with the secret key of the management server 20 is added to each piece of the right information. With this structure, if the right information can be decrypted with the public key of the management server 20, the right information is verified as the one formally issued by the management server 20.

Each piece of the right information is encrypted with the public key of the information processing apparatus 30. With this structure, it is not possible for the information processing apparatuses other than the information processing apparatus to which the right information is issued to sniff or tamper the content of the right information, so that the right information can be safely issued to a desired information processing apparatus.

In the information processing apparatus 30 according to the second embodiment of the present invention, the use controller 340 determines whether the content key can be used on the basis of the presence of the right information including the use key with which the encrypted content key can be decrypted. If the use controller 340 permits the use of the content key, the content using unit 348 extracts the use key from the corresponding right information and decrypts the encrypted content key with the extracted use key to use the content.

An operational flow when the information processing apparatus 30 according to the second embodiment of the present invention uses the encrypted content will now be described.

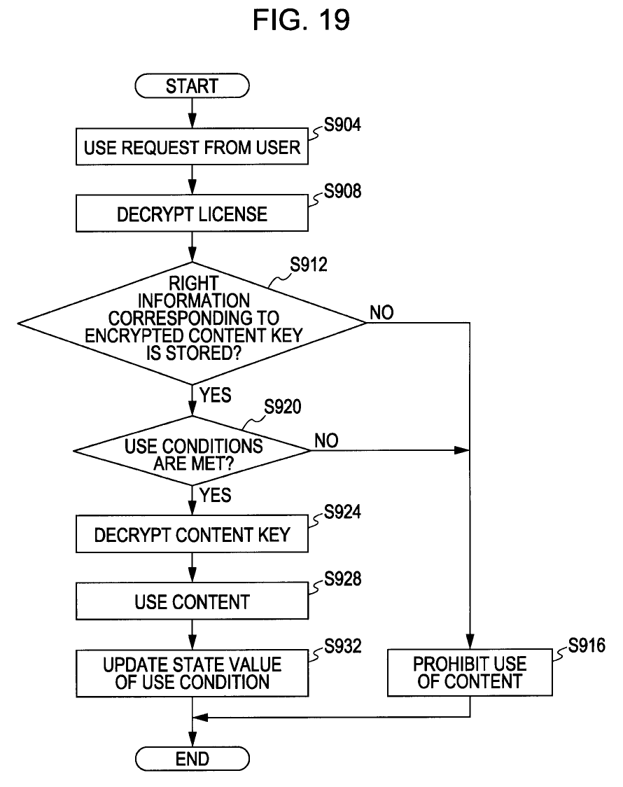

FIG. 19 is a flowchart showing an example of an operational flow of the information processing apparatus 30 according to the second embodiment of the present invention. In Step S904, the information processing apparatus 30 receives a request to export and use the encrypted content from the user and supplies the license that corresponds to the encrypted content to be exported and that is stored in the storage unit 336 to the use controller 340.

In Step S908, the use controller 340 decrypts the license supplied from the storage unit 336 with the user key. In Step S912, the use controller 340 verifies the signature, determines whether the storage unit 336 stores the right information on the export corresponding to the encrypted export content key included in the license, that is, the right information including the export use key with which the export content key can be decrypted, and further verifies the signature if the storage unit 336 stores the above right information.

If the use controller 340 determines that the storage unit 336 does not store the right information on the export corresponding to the encrypted export content key, then in Step S916, the use controller 340 prohibits the export of the encrypted content.

If the use controller 340 determines that the storage unit 336 stores the right information on the export corresponding to the encrypted export content key and the validity of the right information is confirmed by the verification of the signature, then in Step S920, the use controller 340 determines whether the use conditions in the license are met. Specifically, the use controller 340 determines whether the state value about the export included in the license is a positive value. If the use controller 340 determines in Step S920 that the use conditions in the license are not met, then in Step S916, the use controller 340 prohibits the export of the encrypted content.

If the use controller 340 determines in Step S920 that the use conditions in the license are met, the use controller 340 permits the export of the encrypted content. In Step S924, the use controller 340 decrypts the export content key with the export use key. In Step S928, the use controller 340 exports the encrypted content with the decrypted export content key.

In Step S932, the use controller 340 updates the state value included in the license and terminates the operational flow.

As described above, in the content delivery system 10 according to the second embodiment of the present invention, since the management server 20 issues the license including the content key encrypted with the use key, the use of the content key can be restricted to the information processing apparatus that has received the issuance of the right information including the use key from the management server 20.

The management server 20 can update the information processing apparatus to which the use of the content in a specified usage mode is permitted, if necessary. For example, if the export content key included in the license is encrypted, the content can be exported only by the information processing apparatus having the export right information.

In order to update the information processing apparatus that can export the content, for example, the encryption key for the export content key included in the issued license is updated to issue new export right information to the information processing apparatus to which the export is permitted.

Accordingly, even the information processing apparatus to which the export is permitted before the update of the license is prohibited from exporting the content unless the information processing apparatus receives the issuance of the new export right information.

It should be understood by those skilled in the art that various modifications, combinations, sub-combinations and alterations may occur depending on design requirements and other factors insofar as they are within the scope of the appended claims or the equivalents thereof. Although the information processing apparatuses are registered in the groups of users in the above embodiments of the present invention, the information processing apparatuses are not limitedly grouped on the basis of the same user and the information processing apparatuses may be grouped in arbitrary units. In this case, the user key according to the above embodiments of the present invention corresponds to the group key specific to each group and the user ID corresponds to the group ID of each group.

The user key and the encryption key for the signature are not limited to the public key and the secret key on the basis of the public key cryptosystem. A common key which the information processing apparatuses and the management server hold may be used as the user key and the encryption key for the signature.

The steps in the sequence charts and the flowcharts in this specification need not be processed in time series in the order described in the sequence charts and the flowcharts and may be processed in parallel or individually (for example, parallel processes or object processes).

What is claimed is:

1. A management apparatus supplying a license for use of content to an information processing apparatus, the management apparatus comprising:
a group management unit configured to register at least one information processing apparatus in each group and to deliver a group key specific to each group to the information processing apparatus registered in the group;
a storage unit configured to store an ID of the information processing apparatus registered in each group, a group ID of the group to which the information processing apparatus belongs, and the group key, which are in associated with each other;
a license issuing unit configured to issue a license which includes use conditions of the content and a content key with which encrypted content is decrypted and in which at least either of the use conditions of the content and the content key is encrypted with the group key, in response to a request from the information processing apparatus; and
a right information issuing unit configured to issue right information used for permitting the use of the content in a specified usage mode on the basis of the license to the information processing apparatus registered in the group, to which the use of the content in the specified usage mode is permitted.

2. The management apparatus according to claim 1,
wherein the information processing apparatus is registered in the group of each user who owns the information processing apparatus.

3. The management apparatus according to claim 1,
wherein the right information includes a right information ID specific to the right information, and
wherein the right information ID associated with at least one usage mode of the content is described in the use conditions in the license.

4. The management apparatus according to claim 1,
wherein the license includes multiple types of content keys corresponding to the usage modes of the content and at least any of the multiple types of content keys is encrypted with a use key, and
wherein the right information includes the use key with which the encrypted content is decrypted.

5. The management apparatus according to claim 1,
wherein the right information issuing unit restricts the number of the information processing apparatuses to which the right information can be issued so as not to exceed a predetermined upper limit for every usage mode of the content in each registered group of the information processing apparatus owned by the same user.

6. The management apparatus according to claim 5,
wherein the storage unit stores the ID of the information processing apparatus to which the right information has been issued in association with the group ID of the group.

7. The management apparatus according to claim 1,
wherein the storage unit stores the remaining number of times when the content can be used in association with the group ID for every usage mode in the registered group of the information processing apparatus, and
wherein the license issuing unit issues the license in which a state value for every usage mode is set, the state value not exceeding the remaining number of times of use stored in the storage unit, and updates the remaining number of times of use on the basis of the set state value.

8. The management apparatus according to claim 7,
wherein the group management unit receives the state value for every usage mode of the content from the information processing apparatus, along with a request to cancel the registration of the information processing apparatus registered in the group, to update the remaining number of times of use on the basis of the state value.

9. The management apparatus according to claim 1,
wherein the right information issuing unit adds a signature to the right information.

10. An information processing apparatus comprising:
a storage unit configured to store a group key, a license, and right information used for permitting the use of content in a predetermined usage mode on the basis of the license, the group key being specific to a group in which at least one information processing apparatus is registered by a management apparatus, the license including use conditions of the content and a content key with which encrypted content is decrypted, at least either of the use conditions of the content and the content key being encrypted with the group key; and
a use controlling unit configured to decrypt the license with the group key stored in the storage unit in response to a request to use the content in a specified usage mode to control the use of the content on the basis of the decrypted license and the presence of the right information corresponding to the specified usage mode.

11. The information processing apparatus according to claim 10,
wherein the right information includes a right information ID specific to the right information,
wherein the right information ID associated with at least one usage mode of the content is described in the use conditions in the license, and
wherein the use controlling unit controls the use of the content in the usage mode including the right information ID described in the use conditions in the license on the basis of whether the right information corresponding to the right information ID exists.

12. The information processing apparatus according to claim 10,
wherein the license includes multiple types of content keys corresponding to the usage modes of the content and at least any of the multiple types of content keys is encrypted with a use key,
wherein the right information includes the use key with which the encrypted content key is decrypted, and
wherein the use controlling unit controls the use of the encrypted content key corresponding to the specified usage mode on the basis of whether the right information including the use key with which the encrypted content key is decrypted exists.

13. The information processing apparatus according to claim 10, further comprising:
a content using unit configured to use the content in the specified usage mode if the use controlling unit permits the use of the content in the specified usage mode; and
a state storage unit configured to store a state value, which indicates the number of times when the content can be used, described for every usage mode in the use conditions in the license.

14. The information processing apparatus according to claim 13, further comprising:
a registration processing unit configured to transmit the state value stored in the state storage unit to the management apparatus in cancellation of the registration of the information processing apparatus.

15. The information processing apparatus according to claim 10,
wherein a signature is added to the right information and the use controlling unit verifies the validity of the right information on the basis of the signature.

16. The information processing apparatus according to claim 10,
wherein the registration processing unit transmits an ID of the information processing apparatus and an ID of a user who owns the information processing apparatus to the management apparatus when a request to register the information processing apparatus in the group is submitted to the management apparatus.

17. A management method of supplying a license for use of content to an information processing apparatus, the management method comprising the steps of:
registering at least one information processing apparatus which belongs to the same group in one group;
delivering a group key specific to the group to the information processing apparatus registered in the group;
storing an ID of the information processing apparatus registered in the same group, a group ID of the group to which the information processing apparatus belongs, and the group key, which are associated with each other;
issuing a license which includes use conditions of the content and a content key with which encrypted content is decrypted and in which at least either of the use conditions of the content and the content key is encrypted with the group key; and
issuing right information used for permitting the use of the content in a specified usage mode on the basis of the license to the information processing apparatus registered in the group, to which the use of the content in the specified usage mode is permitted.

18. An information processing method comprising the steps of:
storing a group key, a license, and right information used for permitting the use of content in a predetermined usage mode on the basis of the license in a storage unit, the group key being specific to a group in which at least one information processing apparatus is registered by a management apparatus, the license including use conditions of the content and a content key with which encrypted content is decrypted, at least either of the use conditions of the content and the content key being encrypted with the group key;
decrypting the license with the group key in response to a request to use the content in a specified usage mode; and
controlling the use of the content on the basis of the use conditions in the decrypted license and the presence of the right information corresponding to the specified usage mode.

19. A management apparatus supplying a license for use of content to an information processing apparatus, the management apparatus comprising:
group managing means for registering at least one information processing apparatus in each group and delivering a group key specific to each group to the information processing apparatus registered in the group;
storing means for storing an ID of the information processing apparatus registered in each group, a group ID of the group to which the information processing apparatus belongs, and the group key, which are in associated with each other;
license issuing means for issuing a license which includes use conditions of the content and a content key with which encrypted content is decrypted and in which at least either of the use conditions of the content and the content key is encrypted with the group key, in response to a request from the information processing apparatus; and
right information issuing means for issuing right information used for permitting the use of the content in a specified usage mode on the basis of the license to the information processing apparatus registered in the group, to which the use of the content in the specified usage mode is permitted.

20. An information processing apparatus comprising:
storing means for storing a group key, a license, and right information used for permitting the use of content in a predetermined usage mode on the basis of the license, the group key being specific to a group in which at least one information processing apparatus is registered by a management apparatus, the license including use conditions of the content and a content key with which encrypted content is decrypted, at least either of the use conditions of the content and the content key being encrypted with the group key; and
use controlling means for decrypting the license with the group key stored in the storage means in response to a request to use the content in a specified usage mode to control the use of the content on the basis of the decrypted license and the presence of the right information corresponding to the specified usage mode.
